(19) United States
(12) Patent Application Publication
(10) Pub. No.: US 2011/0002216 A1
(43) Pub. Date: Jan. 6, 2011

(54) OPTICAL PICKUP DEVICE AND OPTICAL DISC DEVICE

(75) Inventors: Hiroaki MATSUMIYA, Osaka (JP); Yoshitaka IMAOKA, Kyoto (JP); Jun-ichi ASADA, Hyogo (JP); Yuichi TAKAHASHI, Nara (JP); Kazuo MOMOO, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(73) Assignee: PANASONIC CORPORATION, Osaka (JP)

(21) Appl. No.: 12/796,788

(22) Filed: Jun. 9, 2010

(30) Foreign Application Priority Data
Jun. 11, 2009 (JP) 2009-139736

(51) Int. Cl. G11B 7/135

(52) U.S. Cl. 369/112.23; G9B/7.112

(57) ABSTRACT

Regarding optical pickup devices usable for performing recording on and reproduction from a plurality of types of optical discs, there is a problem that because of the structure of locating many optical elements in a height direction of an optical system, the height of the optical system is increased and so it is difficult to realize a thin and compact optical pickup device. According to the present invention, a first wave plate is located between a first light source and a first mirror, a second wave plate is located between a second light source and a second mirror, and the first wave plate and the second wave plate cause a desirable phase shift to light beams of the first through third wavelengths. Owing to this, the number of optical elements located in the height direction of the optical system can be decreased, and so the height of the optical system can be reduced.

### BACKGROUND OF THE INVENTION

1. Field of the Invention

The present invention relates to an optical pickup device for optically recording or reproducing information on or from an information recording medium such an optical disc or the like using a laser light source, and an optical disc device including the same. Specifically, the present invention relates to a two-lens optical pickup device including two objective lenses and an optical disc device including the same.

2. Description of the Related Art

Recently, optical discs have been progressively increased in the capacity (the recording density), and Blu-ray discs (hereinafter, referred to as the “BDs”) using a blue-violet semiconductor laser element (having a wavelength in a wavelength range around 405 nm) as a light source have been put into practical use.

Meanwhile, conventional optical discs including DVDs using a red semiconductor laser element (having a wavelength in a wavelength range around 660 nm) as a light source, CDs using an infrared semiconductor laser element (having a wavelength in a wavelength range around 790 nm) as a light source and the like are also used widely. Optical discs of a plurality of formats as described above are used today.

In addition, recording/reproduction devices for music and images and information processing devices have been progressively reduced in size to be usable as mobile devices. The optical disc devices and the optical pickup devices to be mounted on these recording/reproduction devices or information processing devices are desired to be more compact, more lightweight and of lower cost.

With such circumstances, an optical disc device which is usable for performing recording on and reproduction from the plurality of types of optical discs and has an optical path commonly usable for BDs, DVDs and CDs for the purpose of size reduction has been proposed (see Japanese Laid-Open Patent Publication No. 2005-85293).

With reference to FIG. 5, an optical system of an optical pickup device having an optical path commonly usable for BDs, DVDs, and CDs will be described.

FIG. 5(a) is a schematic view of an optical system of such an optical pickup device as seen in an X direction, and FIG. 5(b) is a schematic view of the optical system of the optical pickup device as seen in a Y direction. In the figures, a light beam used for performing recording on and reproduction from a BD (BD light beam) 102b is represented with a solid line, a light beam used for performing recording on and reproduction from a DVD (DVD light beam) 101d is represented with a dashed line, and a light beam used for performing recording on and reproduction from a CD (CD light beam) 101c is represented with a two-dot chain line.

Referring to FIG. 5(b), in a light source module 100, a plurality of light sources respectively for emitting light beams of two wavelengths used for performing recording on and reproduction from DVDs and CDs (660 nm for DVDs and 790 nm for CDs) are integrated in one package. On the light beam module 100, a first light source 100d for emitting the DVD light beam 101d and a third light source 100c for emitting the CD light beam 101c are mounted.

The DVD light beam 101d emitted by the first light source 100d is straight polarization polarized in a direction along a Z axis shown in the figure and is incident on a polarization beam splitter 103. A polarization film of the polarization beam splitter 103 has a characteristic of reflecting light having the same polarization direction as that of the DVD light beam 101d emitted by the first light source 100d (direction along the Z axis) or light having a polarization direction along an X axis, and transmitting light having a polarization direction perpendicular thereto (direction along a Y axis). The DVD light beam 101d is reflected by the polarization beam splitter 103 to have the polarization direction thereof changed to be along the X axis and is incident on a polarization beam splitter 104.

The polarization beam splitter 104 has a characteristic of transmitting light having a wavelength of the DVD light beam 101d. Therefore, the DVD light beam 101d passes the polarization beam splitter 104. The DVD light beam 101d, which has passed the polarization beam splitter 104, is incident on a collimator lens 105 shown in FIG. 5(a) to become collimated light.

The DVD light beam 101d, which has become the collimated light, is incident on a first mirror 106. The first mirror 106 has a characteristic of reflecting a light beam having the wavelength of the DVD light beam 101d. Therefore, the DVD light beam 101d is reflected by the first mirror 106 and is incident on a first wave plate 107, while keeping the polarization direction along the X axis, to be converted into circular polarization. The first wave plate acts as a ¼ wave plate for the DVD light beam 101d.

The DVD light beam 101d, which has become the circular polarization, is collected by a first objective lens 108 to be directed to a DVD 10 thus to form a light spot. The DVD light beam 101d, which has been reflected by the DVD 10, again passes the first objective lens 108 and is converted by the first wave plate 107 into straight polarization of a direction perpendicular to the light beam proceeding toward the DVD 10 (straight polarization of the direction along the Z axis). The DVD light beam 101d, which has been converted into the straight polarization, is again reflected by the first mirror 106 to have the polarization direction thereof changed to be along the Y axis and passes the collimator lens 105. Then, the DVD light beam 101d passes the polarization beam splitter 104 shown in FIG. 5(b) and is incident on the polarization beam splitter 103. The polarization beam splitter 103 transmits a light beam having a polarization direction along the Y axis. Therefore, the DVD light beam 101d is transmitted through the polarization beam splitter 103. The DVD light beam 101d, which has been transmitted therethrough, passes a detection lens 120 and is incident on a light detector 121. Thus, various signals including a tracking error signal and a focusing error signal are obtained.

Meanwhile, the BD light beam 102b emitted by a second light source 100b mounted on a laser light source 102 (FIG. 5(b)) is straight polarization polarized in the direction along the Z axis, and passes a relay lens 110 and is incident on the polarization beam splitter 104. The relay lens 110 is provided for guiding the light beam emitted by the second light source 100b to a BD 11 (FIG. 5(a)) efficiently.

A polarization film of the polarization beam splitter 104 has a characteristic of reflecting a light beam having the same polarization direction as that of the BD light beam 102b emitted by the second light source 100b (direction along the Z axis) or a light beam having a polarization direction along the X axis, and transmitting a light beam having a polarization direction perpendicular thereto, i.e., a polarization direction along the Y axis. Therefore, the BD light beam 102b is reflected by the polarization beam splitter 104 to have the polarization direction thereof changed to be along the X axis and is incident on the collimator lens 105 (FIG. 5(a)) to become collimated light.

The BD light beam 102b, which has become the collimated light, is incident on the first mirror 106. The first mirror 106 has a characteristic of transmitting a light beam having a wavelength of the BD light beam 102b. Therefore, the BD light beam 102b is transmitted through the first mirror 106, is reflected by a second mirror 111, and is incident on a second wave plate 112, while keeping the polarization direction along the X axis, to be converted into circular polarization. The second wave plate 112 acts as a ¼ wave plate for the BD light beam 102b.

The BD light beam 102b, which has become the circular polarization, passes a chromatic aberration correction element 113 and is collected by a second objective lens 114 to be directed to the BD 11 thus to form a light spot. The chromatic aberration correction element 113 is used for correcting an axial chromatic aberration caused at the second objective lens 114. The BD light beam 102b, which has been reflected by the BD 11, again passes the second objective lens 114 and the chromatic aberration correction element 113 and is converted by the second wave plate 112 into straight polarization of a direction perpendicular to the light beam proceeding toward the BD 11 (straight polarization of the direction along the Z axis). The BD light beam 102b, which has been converted into the straight polarization, is again reflected by the second mirror 111 to have the polarization direction thereof changed to be along the Y axis and passes the first mirror 106. Then, the BD light beam 102b passes the collimator lens 105 and the polarization beam splitter 104 (FIG. 5(b)) and is incident on the polarization beam splitter 103. The polarization beam splitter 103 has a characteristic of transmitting a light beam having the wavelength of the BD light beam 102b. Therefore, the BD light beam 102b is transmitted through the polarization beam splitter 103, passes the detection lens 120, and is incident on the light detector 121. Thus, various signals including a tracking error signal and a focusing error signal are obtained.

The CD light beam 101c emitted by the third light source 100c (FIG. 5(b)) is straight polarization polarized in the direction along the Z axis shown in the figure, and is incident on the polarization beam splitter 103. The polarization film of the polarization beam splitter 103 has a characteristic of reflecting a light beam having the same polarization direction as that of the CD light beam 101c emitted by the third light source 100c (direction along the Z axis) or a light beam having a polarization direction along the X axis, and transmitting a light beam having a polarization direction perpendicular thereto, i.e., a polarization direction along the Y axis. Therefore, the CD light beam 101c is reflected by the polarization beam splitter 103 to have the polarization direction thereof changed to be along the X axis and is incident on the polarization beam splitter 104.

The polarization beam splitter 104 has a characteristic of transmitting a light beam having a wavelength of the CD light beam 101c. Therefore, the CD light beam 101c is transmitted through the polarization beam splitter 104 and is incident on the collimator lens 105 (FIG. 5(a)) to become collimated light.

The CD light beam 101c, which has become the collimated light, is incident on the first mirror 106. The first mirror 106 has a characteristic of reflecting light having the wavelength of the CD light beam 101c. Therefore, the CD light beam 101c is reflected by the first mirror 106 and is incident on the first wave plate 107, while keeping the polarization direction along the X axis, to be converted into circular polarization. The first wave plate 107 acts as a ¼ wave plate for the CD light beam 101c.

The CD light beam 101c, which has become the circular polarization, is collected by the first objective lens 108 to be directed to a CD 12 thus to form a light spot. The CD light beam 101c, which has been reflected by the CD 12, again passes the first objective lens 108 and is converted by the first wave plate 107 into straight polarization of a direction perpendicular to the light beam proceeding toward the CD 12 (straight polarization of the direction along the Z axis). The CD light beam 101c, which has been converted into the straight polarization, is again reflected by the first mirror 106 to have the polarization direction thereof changed to be along the Y axis and passes the collimator lens 105. Then, the CD light beam 101c passes the polarization beam splitter 104 (FIG. 5(b)) and is incident on the polarization beam splitter 103. The polarization beam splitter 103 transmits a light beam having a polarization direction along the Y axis. Therefore, the CD light beam 101c is transmitted through the polarization beam splitter 103, passes the detection lens 120, and is incident on the light detector 121. Thus, various signals including a tracking error signal and a focusing error signal are obtained.

In the above-described optical pickup device, the reflecting characteristic and the transmitting characteristic of the polarization beam splitters 103 and 104 are set in accordance with each of three wavelengths, and the polarization direction is controlled to be converted by two wave plates. Owing to such a structure, a larger amount of light directed from each light source toward the optical disc can be obtained, and the light emitted by each light source can be guided to the optical disc efficiently. Therefore, such a structure is advantageous to perform recording at a high speed, which requires a larger amount of light for a light spot on the optical disc. In addition, such a structure allows the amount of the light directed from the optical disc toward the light detector 121 to be set larger. Therefore, light from an optical disc having a lower reflectance, which is especially often seen as an optical disc for recording, can be detected by the light detector efficiently. This realizes a good recording performance.

For these reasons, the optical pickup devices usable for performing recording on an optical disc adopt the above-described structure referred to as the “polarization optical system”.

### SUMMARY OF THE INVENTION

In general, the “thickness direction” of an optical pickup device is the direction along the Y axis in FIG. 5. Since optical disc devices are desired to be thinner as described above, optical pickup devices are strongly desired to be thinner, namely, to be reduced in size in the thickness direction.

The thickness of an optical pickup device is mostly occupied by a length H of the optical system along the Y axis, which is represented by the two-headed arrow in FIG. 5 (hereinafter, referred to as the “height of the optical system”). Therefore, the height H of the optical system needs to be reduced.

However, in an optical pickup device as described above, especially in the optical system for BDs, the second objective lens 114, the chromatic aberration correction element 113, and the second wave plate 112 are located in the height direction. This increases the overall height of the optical system, which is an obstacle against the size reduction of the optical pickup device.

In general, CDs are known to occasionally have a large birefringence in a substrate thereof. It is also known that when a CD light beam having circular polarization or elliptical polarization is incident on such a CD, a phase shift corresponding to the amount of the birefringence of the CD is caused to the CD light beam and so the polarization state of the CD light beam is converted.

Therefore, in the above case, a phase shift corresponding to the amount of the birefringence of the CD 12 is caused to the CD light beam 101c incident on the CD 12 in the state of circular polarization, and the CD light beam 101c is converted into elliptical polarization. Furthermore, the CD light beam 101c incident on the first wave plate 107 acting as the ¼ wave plate is converted into elliptical polarization as a result of a phase shift corresponding to the amount of the birefringence of the CD 12 being added to the straight polarization having a polarization direction along the Z axis. While keeping this polarization state, the CD light beam 101c is reflected by the first mirror 106, is transmitted through the collimator lens 105 and the polarization beam splitter 104, and is incident on the polarization beam splitter 103.

The polarization film of the polarization beam splitter 103 has a characteristic of reflecting a light beam having the same polarization direction as that of the CD light beam 101c emitted by the third light source 100c (direction along the Z axis) or a light beam having a polarization direction along the X axis, and transmitting a light beam having a polarization direction perpendicular thereto, i.e., a polarization direction along the Y axis. Therefore, of the CD light beam 101c converted into the elliptical polarization by the phase shift corresponding to the amount of the birefringence of the CD 12, a component having a polarization direction along the X axis is reflected by the polarization beam splitter 103, and only a component having a polarization direction along the Y axis is transmitted through the polarization beam splitter 103.

Accordingly, with respect to the light beam 101c reflected by the CD 12, the ratio of the light beam transmitted through the polarization beam splitter 103 is decreased, and so the amount of the light beam passing the detection lens 120 and incident on the light detector 121 is decreased. As a result, the quality of various signals obtained from such a light beam is deteriorated.

The present invention made with an attention to the above problems provides an optical pickup device and an optical disc device which are thin and compact and have a high recording/reproduction performance.

An optical pickup device according to the present invention includes a first objective lens and a second objective lens and capable of collecting a light beam to at least three types of optical discs. The optical pickup device includes a first light source for emitting a light beam of a first wavelength; a second light source for emitting a light beam of a second wavelength; a third light source for emitting a light beam of a third wavelength; a first mirror for reflecting the light beam of the first wavelength and the light beam of the third wavelength and transmitting the light beam of the second wavelength; a second mirror for reflecting the light beam of the second wavelength which has been transmitted through the first mirror; a first wave plate located between the first light source and the first mirror; and a second wave plate located between the second light source and the second mirror. The first objective lens collects the light beam of the first wavelength and the light beam of the third wavelength, which have been reflected by the first mirror, on a first optical disc and a third optical disc, respectively; the second objective lens collects the light beam of the second wavelength, which has been reflected by the second mirror, on a second optical disc; and a total sum of phase shifts caused by the first wave plate and the second wave plate is (2i+1)×90°±20° to the light beam of the first wavelength (i is an integer), (2i+1)×90°±20° to the light beam of the second wavelength, and 0°±20° to the light of the third wavelength.

In one embodiment, a crystal axis of the first wave plate and a crystal axis of the second wave plate are perpendicular to each other.

In one embodiment, the first wave plate and the second wave plate are integrated together.

In one embodiment, the optical pickup device further includes a chromatic aberration correction element for correcting an axial chromatic aberration caused at the second objective lens; and a relay lens for improving a utilization factor of the light beam of the second wavelength. The chromatic aberration correction element and the relay lens are integrated together.

In one embodiment, the first light source and the third light source are integrated in a common package.

In one embodiment, the first light source, the second light source and the third light source are integrated in a common package.

An optical pickup device according to the present invention includes a first objective lens and a second objective lens and capable of collecting a light beam to at least three types of optical discs. The optical pickup device includes a first light source for emitting a light beam of a first wavelength; a second light source for emitting a light beam of a second wavelength; a third light source for emitting a light beam of a third wavelength; a first mirror for reflecting the light beam of the first wavelength and the light beam of the third wavelength and transmitting the light beam of the second wavelength; a second mirror for reflecting the light beam of the second wavelength which has been transmitted through the first mirror; a first wave plate located between the first light source and the first mirror; and a second wave plate located between the first mirror and the second mirror. The first objective lens collects the light beam of the first wavelength and the light beam of the third wavelength, which have been reflected by the first mirror, on a first optical disc and a third optical disc, respectively; the second objective lens collects the light beam of the second wavelength, which has been reflected by the second mirror, on a second optical disc; and a phase shift caused by the first wave plate to the light beam of the first wavelength is (2i+1)×90°±20° (i is an integer); a total sum of phase shifts caused by the first wave plate and the second wave plate to the light beam of the second wavelength is (2i+1)×90°±20°; and a phase shift caused by the first wave plate to the light beam of the third wavelength is 0°±20°.

In one embodiment, a phase shift caused by the first wave plate to the light beam of the second wavelength is 0°.

In one embodiment, a crystal axis of the first wave plate and a crystal axis of the second wave plate are perpendicular to each other.

In one embodiment, the optical pickup device further includes a chromatic aberration correction element for correcting an axial chromatic aberration caused at the second objective lens; and a relay lens for improving a utilization factor of the light beam of the second wavelength. The chromatic aberration correction element and the relay lens are integrated together.

In one embodiment, the first light source and the third light source are integrated in a common package.

In one embodiment, the first light source, the second light source and the third light source are integrated in a common package.

According to the present invention, the first wave plate is located between the first light source and the first mirror. The second wave plate is located between the second light source and the second mirror, on an optical path of the light beam of the second wavelength which is output by the second light source. Owing to this, the number of optical elements located in the height direction can be decreased, and so an optical pickup device and an optical disc device which are thin with the thickness being suppressed and compact can be provided. Since the first wave plate and the second wave plate cause a desirable phase shift to the light beams of the first through third wavelengths, an optical pickup device and an optical disc device which are thin and compact and have a good recording/reproduction performance can be provided.

According to the present invention, an optical pickup device and an optical disc device which are thin, compact, and of lower cost and have a good reproduction/recording performance for a plurality of types of optical discs can be realized.

### BRIEF DESCRIPTION OF THE DRAWINGS

FIGS. 1(a) and 1(b) show an optical system of an optical pickup device in Embodiment 1 of the present invention.

FIG. 2 shows wave plates in Embodiment 1.

FIGS. 3(a) and 3(b) show an optical system of an optical pickup device in Embodiment 2 of the present invention.

FIG. 4 shows wave plates in Embodiment 2.

FIGS. 5(a) and 5(b) show an optical system of an optical pickup device.

### DETAILED DESCRIPTION OF PREFERRED EMBODIMENTS

### Embodiment 1

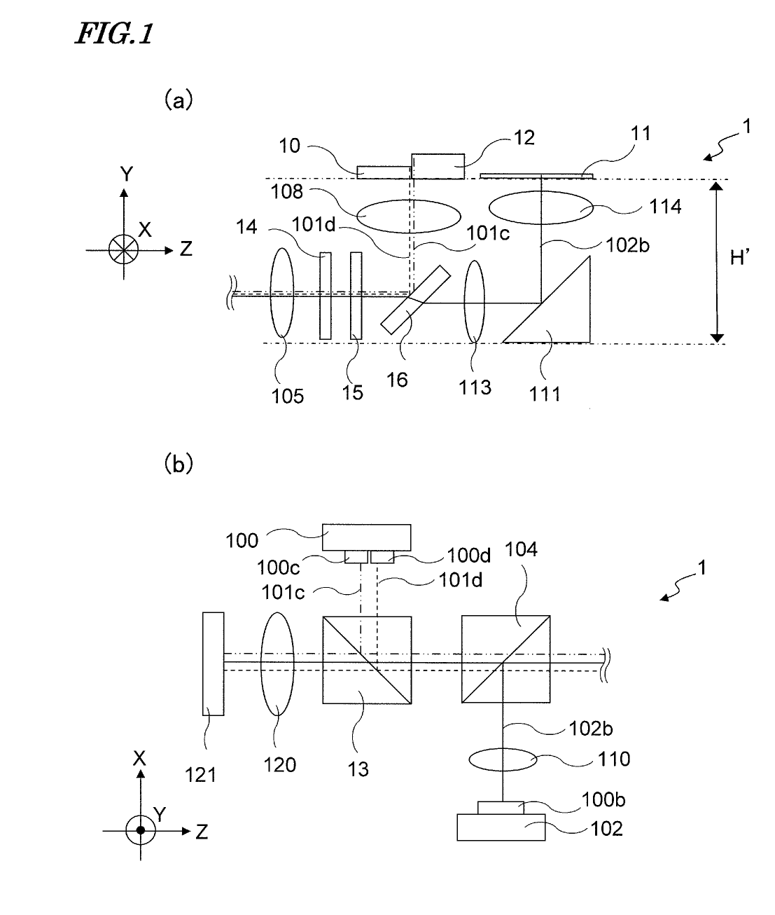

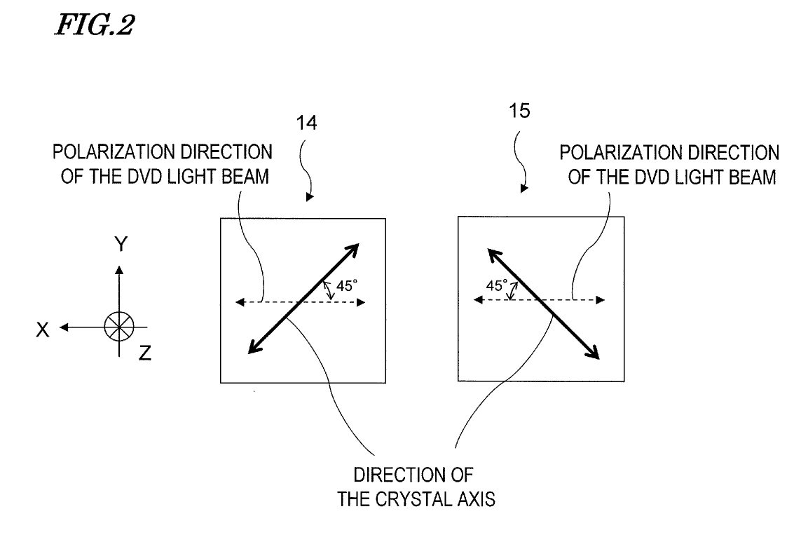

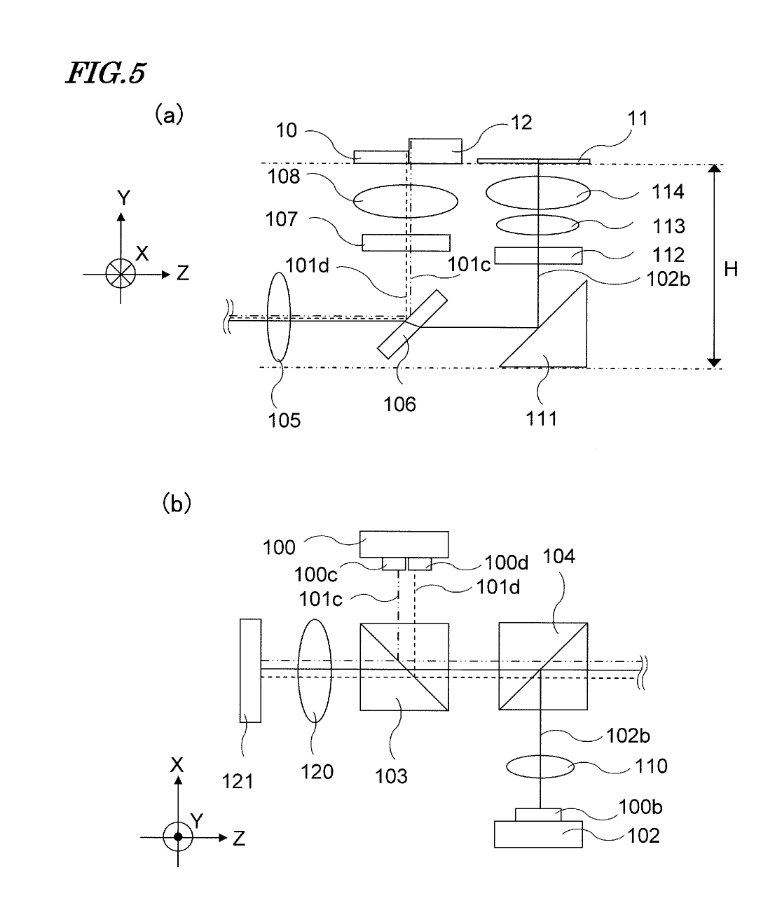

With Reference to FIGS. 1 and 2, an Optical Pickup device in Embodiment 1 of the present invention will be described. Identical elements as those of the example shown in FIG. 5 will be described with identical reference numerals thereto.

FIG. 1(a) is a schematic view of an optical system of an optical pickup device 1 as seen in the X direction, and FIG. 1(b) is a schematic view of the optical system of the optical pickup device 1 as seen in the Y direction. In FIG. 1, the BD light beam 102b is represented with a solid line, the DVD light beam 101d is represented with a dashed line, and the CD light beam 101c is represented with a two-dot chain line. The optical pickup device 1 is a two-lens optical pickup device including two objective lenses, and can collect a light beam to at least three types of optical discs for data recording/reproduction. In this embodiment, BD, DVD and CD will be described as examples of the optical discs.

Referring to FIG. 1(b), in the light source module 100, a plurality of light sources respectively for emitting light beams of two wavelengths used for performing recording on and reproduction from DVDs and CDs (660 nm, 790 nm) are integrated in one package. On the light beam module 100, the first light source 100d for emitting the DVD light beam 101d and the third light source 100c for emitting the CD light beam 101c are mounted.

The DVD light beam 101d emitted by the first light source 100d is straight polarization polarized in the direction along the Z axis shown in the figure and is incident on a polarization beam splitter 13. A polarization film of the polarization beam splitter 13 has a characteristic of reflecting a light beam having the same polarization direction as that of the DVD light beam 101d emitted by the first light source 100d (direction along the Z axis) and transmitting a light beam having a polarization direction perpendicular thereto (direction along the Y axis). The DVD light beam 101d is reflected by the polarization beam splitter 13 to have the polarization direction thereof changed to be along the X axis and is incident on the polarization beam splitter 104.

The polarization beam splitter 104 has a characteristic of transmitting light having the wavelength of the DVD light beam 101d. Therefore, the DVD light beam 101d passes the polarization beam splitter 104, is incident on a collimator lens 105 (FIG. 1(a)) to become collimated light, and is incident on a first wave plate 14.

A wave plate is formed of crystal having optical anisotropy (for example, quartz, etc.) and causes a phase shift (retardation Γ) by a refractive index difference (Δn) between ordinary light and extraordinary light to the wavelength λ of the light used. In order to cause a desirable phase shift, the thickness d of the crystal needs to be set.

The retardation Γ and the thickness d have the relationship of:

Γ=Δn×d (expression 1)

For example, it is now assumed that quartz is used as the crystal forming the first wave plate 14. In order to cause a phase shift of ¼ wavelength, namely, 90° (retardation Γ=158 nm) to light having a wavelength of 633 nm, in the case where the refractive index to the ordinary light is 1.5426 and the refractive index to the extraordinary light is 1.5526, the refractive index difference Δn is 0.01. The required crystal thickness d₁ is d₁=15.8 μl.

Crystal thicknesses d₁ and d₂ of the two wave plates, namely, the first wave plate 14 and a second wave plate 15 are each set such that the phase shift caused by the light passing through the first wave plate 14 and the second wave plate 15 is 90° or 270° to light having a wavelength λ_{d} of the DVD light beam 101d and light having a wavelength λ_{b} of the BD light beam 102b and is 0° to light having a wavelength λ_{c} of the CD light beam 101c. The thickness d₂ is the thickness of the crystal forming the second wave plate 15.

In the optical pickup device 1 in this embodiment, the crystal thickness d₁ of the first wave plate 14 is set such that the phase shift is 90° or 270° to light having the wavelength λ_{d} of the DVD light beam 101d and is 0° to light having the wavelength λ_{b} of the BD light beam 102b and light having the wavelength λ_{c} of the CD light beam 101c.

For example, where λ_{b}=405 nm, λ_{d}=660 nm, and λ_{c}=795 nm; the refractive index difference at the crystal forming the first wave plate 14 is Δnλ_{b} at λ_{b}, Δnλ_{d} at λ_{d}, and Δnλ_{c} at λ_{c}; and Δnλ_{b}=Δnλ_{d}=Δnλ_{c}=0.01; the crystal thickness d₁ is set to 82.5 μm.

At this point, the retardation Γ₁ of the first wave plate 14 is Γ₁=825 nm, and the following expression holds.

Γ₁=(1+¼)×λ_{d}≈2×λ_{b}≈1×λ_{c} (expression 2)

Therefore, the phase shift caused to the DVD light beam 101d is 90°, and the phase shift caused to the BD light beam 102b and the CD light beam 101c is 0°.

The first wave plate 14 is located such that a crystal axis having optical anisotropy has an angle of 45° with respect to the polarization direction of the DVD light beam (direction along the X axis) on an X-Y plane. Therefore, the DVD light beam 101d is converted into circular polarization and is incident on the second wave plate 15.

The crystal thickness d₂ of the second wave plate 15 is set such that the phase shift is 0° to light having the wavelength λ_{d} of the DVD light beam 101d and the wavelength λ_{c} of the CD light beam 101c and is 90° or 270° to light having the wavelength λ_{b} of the BD light beam 102b.

For example, where λ_{b}=405 nm, λ_{d}=660 nm, and λ_{c}=795 nm; the refractive index difference at the crystal forming the second wave plate 15 is Δnλ_{b} at λ_{b}, Δnλ_{d} at λ_{d} and Δnλ_{c} at λ_{c}; and Δnλ_{b}=Δnλ_{d}=Δnλ_{c}=0.01; the crystal thickness d₂ is set to 396 μm.

At this point, the retardation Γ₂ of the second wave plate 15 is Γ₂=3960 nm, and the following expression holds.

Γ₂=6×λ_{d}≈(9+¾)×λ_{b}≈5×λ_{c} (expression 3)

Therefore, the phase shift caused to the DVD light beam 101d and the CD light beam 101c is 0°, and the phase shift caused to the BD light beam 102b is 270°.

Accordingly, the DVD light beam 101d passes the second wave plate 15 while keeping the circular polarization state.

The DVD light beam 101d is incident on a first mirror 16. The first mirror 16 has a characteristic of reflecting a light beam having the wavelength of the DVD light beam 101d. Therefore, the DVD light beam 101d is reflected by the first mirror 16 and is collected by the first objective lens 108 to be directed to the DVD 10 thus to form a light spot.

The DVD light beam 101d, which has been reflected by the DVD 10, again passes the first objective lens 108, is reflected by the first mirror 16, passes the second wave plate 15 while keeping the circular polarization, and is converted by the first wave plate 14 into straight polarization of a direction perpendicular to the light beam proceeding toward the DVD 10 (straight polarization of the direction along the Y axis). The DVD light beam 101d, which has been converted into the straight polarization, passes the collimator lens 105, is transmitted through the polarization beam splitter 104 (FIG. 1(b)), and is incident on the polarization beam splitter 13. The polarization beam splitter 13 transmits a light beam having a polarization direction along the Y axis. Therefore, the DVD light beam 101d is transmitted through the polarization beam splitter 13, passes the detection lens 120, and is incident on the light detector 121. Thus, various signals including a tracking error signal and a focusing error signal are obtained.

Meanwhile, the BD light beam 102b emitted by the second light source 100b mounted on the laser light source 102 (FIG. 1(b)) is straight polarization polarized in the direction along the Z axis, and passes the relay lens 110 and is incident on the polarization beam splitter 104. The relay lens 110 is provided for guiding the light beam emitted by the second light source 100b to the BD 11 efficiently. The provision of the relay lens 110 allows the second light source 100b to be located closer to the polarization beam splitter 104, and so is advantageous to reduce the size of the optical pickup device.

The polarization film of the polarization beam splitter 104 has a characteristic of reflecting a light beam having the same polarization direction as that of the BD light beam 102b emitted by the second light source 100b (direction along the Z axis) or a light beam having a polarization direction along the X axis, and transmitting a light beam having a polarization direction perpendicular thereto, i.e., a polarization direction along the Y axis. Therefore, the BD light beam 102b is reflected by the polarization beam splitter 104, is incident on the collimator lens 105 (FIG. 1(a)) to become collimated light, and is incident on the first wave plate 14.

The first wave plate 14 causes a phase shift of 0° to light having the wavelength λ_{b} of the BD light beam 102. Therefore, the polarization state of the BD light beam is not changed, and the BD light beam is incident on the second wave plate 15 while keeping the polarization direction along the X axis.

The second wave plate 15 causes a phase shift of 90° or 270° to light having the wavelength λ_{b} of the BD light beam. The second wave plate 15 is located such that a crystal axis, having optical anisotropy, of the crystal forming the second wave plate 15 has an angle of 45° with respect to the polarization direction of the BD light beam (direction along the X axis) on the X-Y plane. Therefore, the BD light beam 102b is converted into circular polarization and is incident on the first mirror 16.

The first mirror 16 has a characteristic of transmitting a light beam having the wavelength of the BD light beam 102b. Therefore, the BD light beam 102b is transmitted through the first mirror 16, passes the chromatic aberration correction element 113, is reflected by the second mirror 111, and is collected by the second objective lens 114 to be directed to the BD 11 thus to form a light spot. The chromatic aberration correction element 113 is used for correcting an axial chromatic aberration caused by the second objective lens 114.

The BD light beam 102b, which has been reflected by the BD 11, again passes the second objective lens 114, is reflected by the second mirror 111, passes the chromatic aberration correction element 113 and the first mirror 16, and is converted by the second wave plate 15 into straight polarization of a direction perpendicular to the light beam proceeding toward the BD 11, i.e., straight polarization of the direction along the Y axis. The BD light beam 102b, which has been converted into the straight polarization, is transmitted through the first wave plate 14 while keeping the polarization state, is transmitted through the collimator lens 105 and the polarization beam splitter (FIG. 1(b)), and is incident on the polarization beam splitter 13.

The polarization beam splitter 13 has a characteristic of transmitting a light beam having the wavelength of the BD light beam 102b. Therefore, the BD light beam 102b is transmitted through the polarization beam splitter 13, passes the detection lens 120, and is incident on the light detector 121. Thus, various signals including a tracking error signal and a focusing error signal are obtained.

The CD light beam 101c emitted by the third light source 100c is straight polarization polarized in the direction along the Z axis, and is incident on the polarization beam splitter 13. The CD light beam 101c, which has been incident on the polarization beam splitter 13, is divided into a light beam reflected by the polarization beam splitter 13 and a light beam transmitted through the polarization beam splitter 13. The CD light beam 101c reflected by the polarization beam splitter 13 has the polarization direction thereof changed to be along the X axis and is incident on the polarization beam splitter 104.

The polarization beam splitter 104 has a characteristic of transmitting a light beam having the wavelength of the CD light beam 101c. Therefore, the CD light beam 101c passes the polarization beam splitter 104, is incident on the collimator lens 105 (FIG. 1(a)) to become collimated light, and is incident on the first wave plate 14.

The first wave plate 14 causes a phase shift of 0° to a light beam having the wavelength λ_{c} of the CD light beam. Therefore, the polarization state of the CD light beam is not changed, and the CD light beam is incident on the second wave plate 15 while keeping the polarization direction along the X axis.

The second wave plate 15 also causes a phase shift of 0° to a light beam having the wavelength λ_{c} of the CD light beam. Therefore, the polarization state of the CD light beam is not changed, and the CD light beam is incident on the first mirror 16 while keeping the polarization direction along the X axis.

The first mirror 16 has a characteristic of reflecting a light beam having the wavelength of the CD light beam 101c. Therefore, the CD light beam 101c is reflected by the first mirror 16, and is collected by the first objective lens 108 while keeping the polarization direction along the X axis to be directed to the CD 12 thus to form a light spot.

The CD light beam 101c, which has been reflected by the CD 12, again passes the first objective lens 108, is reflected by the first mirror 16, and passes the second wave plate 15 and the first wave plate 14 while keeping the polarization direction along the X axis. Then, the CD light beam 101c passes the collimator lens 105, is transmitted through the polarization beam splitter 104 (FIG. 1(b)), and is incident on the polarization beam splitter 13. The CD light beam 101c, which has been incident on the polarization beam splitter 13, is divided into a light beam reflected by the polarization beam splitter 13 and a light beam transmitted through the polarization beam splitter 13. The CD light beam 101c transmitted through the polarization beam splitter 13 passes the detection lens 120 and is incident on the light detector 121. Thus, various signals including a tracking error signal and a focusing error signal are obtained.

Even in the case where a substrate of the CD 12 has a large birefringence, no phase shift is caused to the CD light beam 101c when the CD light beam 101c incident on the CD 12 is straight polarization having a polarization direction along the X axis or the Z axis.

Since the CD light beam 101c incident on the CD 12 is straight polarization having a polarization direction along the X axis, no phase shift is caused to the CD light beam 101c even in the case where the substrate of the CD 12 has a large birefringence. The CD light beam 101c, which has been incident on, and reflected by, the CD 12, is straight polarization having a polarization direction along the X axis.

Therefore, in this case also, the ratio of the CD light beam 101c transmitted through the polarization beam splitter 13 is the same as that in the case where the substrate of the CD 12 does not have a birefringence. The amount of the light beam 101c which passes the detection lens 120 and is incident on the light detector 121 is the same.

Therefore, the amount of the CD light beam 101c incident on the light detector 121 is the same regardless of the amount of the birefringence of the CD 12. For this reason, a good quality signal can be obtained, and a good recording/reproduction performance is obtained.

Owing to the above-described structure, a polarization optical system capable of obtaining a sufficient utilization factor of the light beam from the light source for performing recording on and reproduction from a BD and a DVD and thus guiding the light reflected from a low reflectance disc to the light detector efficiently can be realized. Also a good quality signal can be obtained for a CD having a birefringence. By providing the above-described features and also adopting a structure in which only the objective lenses are located as optical elements in a height direction of the optical system, a height H′ represented with the two-headed arrow in FIG. 1(a) can be reduced. Owing to these features, a thin and compact optical pickup device having a good recording/reproduction performance can be realized.

The structure of the optical system of the optical pickup device 1 in this embodiment is one example, and the present invention is not limited to this. For example, the first wave plate 14 may be located between the polarization beam splitter 104 and the collimator lens 105. The structure of the optical system is not limited to the one in this embodiment.

In the optical pickup device 1 in this embodiment, the phase shift caused by the light passing the two wave plates, i.e., the first wave plate 14 and the second wave plate 15 is set to 90° or 270° to a light beam having the wavelength λ_{d} of the DVD light beam 101d and a light beam having the wavelength λ_{b} of the BD light beam 102b and to 0° to a light beam having the wavelength λ_{c} of the CD light beam 101c. For example, the first wave plate 14 is set to cause a phase shift of 90° or 270° to a light beam having the wavelength λ_{d} of the DVD light beam 101d and a phase shift of 0° to a light beam having the wavelength λ_{b} of the BD light beam 102b and a light beam having the wavelength λ_{c} of the CD light beam 101c. At the same time, the second wave plate 15 is set to cause a phase shift of 0° to a light beam having the wavelength λ_{d} of the DVD light beam 101d and a light beam having the wavelength λ_{c} of the CD light beam 101c and a phase shift of 90° or 270° to a light beam having the wavelength λ_{b} of the BD light beam 102b. The present invention is not limited to this combination, and any other combination is usable as long as the same phase shifts are caused.

For example, even in the case where the phase shift caused by the first wave plate 14 to the DVD light beam is other than 90° or 270°, a total sum of the phase shifts caused to the DVD light beam when the DVD light beam passes the first wave plate 14 and the second wave plate 15 can be 90° or 270° by setting the phase shift caused by the second wave plate 15 to the DVD light beam to a desirable value.

Similar setting can be done to the BD light beam and the CD light beam. In this case, a larger number of combinations of the crystal thickness d₁ of the first wave plate 14 and the crystal thickness d₂ of the second wave plate 15 are conceivable for the three wavelengths. Therefore, the degree of designing freedom is increased.

In the above-described structure, a crystal axis of the first wave plate 14 and a crystal axis of the second wave plate 15 may be perpendicular to each other.

In the optical pickup device in this embodiment, the crystal thickness d₁ of the first wave plate 14 is set such that the phase shift is 90° or 270° to a light beam having the wavelength λ_{d} of the DVD light beam 101d and is 0° to a light beam having the wavelength λ_{b} of the BD light beam 102b and a light beam having the wavelength λ_{c} of the CD light beam 101c. This is realized by, for example, the following. Where λ_{b}=405 nm, λ_{d}=660 nm, and λ_{c}=795 nm; the refractive index difference at the crystal forming the first wave plate 14 is Δnλ_{b} at λ_{b}, Δnλ_{d} at λ_{d}, and Δnλ_{c} at λ_{c}; and Δnλ_{b}=Δnλ_{d}=Δnλ_{c}=0.01; the crystal thickness d₁ is set to 82.5 μm so that the retardation Γ₁ is 825 nm.

In general, however, the wave plate cannot be produced at low cost because it is difficult or costly to process quartz to a thickness of 82.5 μm with highly precisely and also other elements for holding the crystal is required to make the wave plate rigid.

Therefore, the following is needed. The retardation Γ₁ of the wave plate is represented by:

Γ₁=λ_{d}×(n±¼)(n=1,2,3, . . . ) (expression 4)

In expression 4, a large value needs to be used as “n” such that the required thickness of the crystal is a thickness to which the crystal is processable. For example, in the case where n=4 and λ_{d}=660 nm, the retardation Γ₁ of the wave plate is Γ₁=660×(4−¼)=2475 nm. In this case, the required thickness of the quartz is 248 μm, to which the quartz can be processed easily. By increasing the value of “n”, the thickness of the crystal can be increased. Thus, the processability is improved, which allows the wave plate to be produced at lower cost.

Similarly, the second wave plate 15 is set to cause a phase shift of 0° to the DVD light beam having the wavelength Therefore, the thickness of the second wave plate 15 is set such that the retardation Γ₂ thereof is:

Γ₂=λ_{d}×m(m=1,2,3, . . . ) (expression 5)

For example, in the case where m=6 and λ_{d}=660 nm, the retardation Γ₂ of the wave plate is Γ₂=660×6=3960 nm. In this case, the required thickness of the quartz is 396 μm.

However, it is generally known that when the ambient temperature or the intensity of the light beam emitted by the light source is changed, the wavelength of the light beam is changed. When the wavelength λ_{d} of the DVD light beam is changed to λ_{d}′, the first wave plate 14, which is set to cause a phase shift of 90° or 270° to the DVD light beam having the wavelength λ_{d}, causes a phase shift having a certain error with respect to 90° or 270° to the DVD light beam having the wavelength λ_{d}, based on expression 4.

Similarly, at this point, the second wave plate 15 also causes a phase shift having a certain error with respect to 0°.

An ideal retardation Γ₁′ for causing a phase shift of 90° or 270° by the first wave plate 14 to the DVD light beam having the wavelength λ_{d}′ is:

Γ₁′=λ_{d}′×(n±¼) (expression 6)

An ideal retardation Γ₂′ for causing a phase shift of 0° by the second wave plate 15 to the DVD light beam having the wavelength λ_{d}′ is:

Γ₂′=λ_{d}′×m (expression 7)

At this point, retardation errors ΔΓ₁ and ΔΓ₂ corresponding to the errors of the phase shifts caused by the first and second wave plates are respectively as follows based on expressions 4 through 7.

$$\begin{matrix}\begin{matrix}Δ {Γ}_{1} = {Γ}_{1} - {Γ}_{1}^{′} \\ = {λ}_{d} \times ( n \pm 1 / 4 ) - {λ}_{d}^{′} \times ( n \pm 1 / 4 ) \\ = ( {λ}_{d} - {λ}_{d}^{′} ) \times ( n \pm 1 / 4 )\end{matrix} & ( expression 8 ) \\ \begin{matrix}{ΔΓ}_{2} = {Γ}_{2} - {Γ}_{2}^{′} \\ = {λ}_{d} \times m - {λ}_{d}^{′} \times m \\ = ( {λ}_{d} - {λ}_{d}^{′} ) \times m\end{matrix} & ( expression 9 )\end{matrix}$$

As a result, a retardation error ΔΓ_{d} corresponding to a total sum of the phase shift errors caused by the DVD light beam having the wavelength λ_{d}′ passing the first wave plate 14 and the second wave plate 15 is:

$$\begin{matrix}{ΔΓ}_{d} = {ΔΓ}_{1} - {ΔΓ}_{2} \\ = ( {λ}_{d} - {λ}_{d}^{′} ) \times ( n + m \pm 1 / 4 )\end{matrix} \qquad ( expression 10 )$$

Accordingly, at the first wave plate 14, because of the phase shift error corresponding to ΔΓ₁, the DVD light beam 101d is changed to elliptical polarization, which is diverged from the circular polarization. At the second wave plate 15, as a result of the phase shift error corresponding to ΔΓ₂ being added, the DVD light beam 101d is further changed to elliptical polarization including such a phase shift.

The DVD light beam 101d, which has been incident on, and reflected by, the DVD 10 and again incident on the second wave plate 15, again becomes elliptical polarization including a phase shift error corresponding to ΔΓ₂ and is incident on the first wave plate 14. The first wave plate 14 again causes a phase shift error corresponding to ΔΓ₁, and the DVD light beam 101d is converted into elliptical polarization diverged from the straight polarization of the direction along the Y axis and is incident on the polarization beam splitter 104.

At this point, the polarization beam splitter 13 transmits a light beam having a polarization direction along the Y axis and reflects a light beam having a polarization direction along the X axis. The DVD light beam, which is elliptical polarization, includes a component which has a polarization direction along the X axis and does not proceed toward the light detector 121. Therefore, the amount of the DVD light beam 101d incident on the light detector 121 is decreased. Therefore, the amount of the light required for performing recording on or reproduction from the DVD 10 is not obtained, and so the recording/reproduction performance is deteriorated.

Especially according to expression 10, when the thickness is increased, i.e., the values of n and m are increased in order to allow the first and second wave plates to be produced by processing, the retardation error ΔΓ_{d} is increased. Therefore, the phase shift error caused when the light passes the first and second wave plates reciprocally is still increased and the amount of component proceeding toward the light detector 121 is still decreased. As a result, the amount of the light obtained at the light detector 121 is still decreased, which further deteriorates the recording/reproduction performance.

In order to solve this problem, in this embodiment, the crystal axis of the first wave plate 14 and the crystal axis of the second wave plate 15 are located to be perpendicular to each other as shown in FIG. 2.

FIG. 2 is a plan view showing the crystalline axes of the wave plates as seen in the direction in which the DVD light beam 101d emitted by the first light source 100d and proceeding toward the DVD 10 is incident on the wave plates. In FIG. 2, the crystal axis of the first wave plate 14 (represented with the thick solid arrow in the figure) is set to a direction of 45° counterclockwise with respect to the polarization direction of the DVD light beam 101d (direction along the X axis; represented with the dashed line in the figure) on the X-Y plane. The crystal axis of the second wave plate 15 (represented with the thick solid arrow in the figure) is set to a direction of 45° clockwise with respect to the polarization direction of the DVD light beam 101d (direction along the X axis; represented with the dashed line in the figure) on the X-Y plane.

The second wave plate 15 is set to cause a phase shift of 0° to the DVD light beam 101d having the wavelength λ_{d}. The crystalline axes of the first wave plate 14 and the second wave plate 15 are perpendicular to each other. Therefore, the phase shift caused by the first wave plate 14 and the phase shift caused by the second wave plate 15 are of opposite polarity to each other. The retardation Γ₂ of the second wave plate 15 is:

Γ₂=−λ_{d}×m(m=1,2,3, . . . ) (expression 11)

Meanwhile, the ideal retardation Γ₂′ for causing a phase shift of 0° by the second wave plate 15 to the DVD light beam having the wavelength λ_{d}′ is:

Γ₂′=−λ_{d}′×m (expression 12)

At this point, the retardation error ΔΓ₂ corresponding to the phase shift error caused by the second wave plate 15 is:

$$\begin{matrix}{ΔΓ}_{2} = {Γ}_{2} - {Γ}_{2}^{′} \\ = - {λ}_{d} \times m - ( - {λ}_{d}^{′} \times m ) \\ = - ( {λ}_{d} - {λ}_{d}^{′} ) \times m\end{matrix} \qquad ( expression 13 )$$

As a result, the retardation error ΔΓ_{d} corresponding to the total sum of the phase shift errors caused by the DVD light beam having the wavelength λ_{d}′ passing the first wave plate and the second wave plate is:

$$\begin{matrix}{ΔΓ}_{d} = {ΔΓ}_{1} + {ΔΓ}_{2} \\ = ( {λ}_{d} - {λ}_{d}^{′} ) \times ( n - m \pm 1 / 4 )\end{matrix} \qquad ( expression 14 )$$

Therefore, according to expression 14, by selecting the value of each of n and m so as to decrease the value of (n−m), the retardation error ΔΓ_{d} can be decreased and the corresponding phase shift error can be decreased. By setting n=m, the retardation error ΔΓ_{d} can be minimized.

Therefore, even in the case where the wavelength of the DVD beam light is changed when the crystal thicknesses, i.e., the values of n and m are set to have large values in order to allow the wave plates to be produced at lower cost, the divergence of the polarization state of the DVD light beam from the desirable polarization state can be suppressed to be small. Thus, the decrease of the amount of the light incident on the light detector 121 can be suppressed and the deterioration of the DVD recording/reproduction performance can be suppressed.

The above-described structure is also effective to the BD light beam in the polarization optical system. A good BD recording/reproduction performance can be realized while using the crystal thickness of the wave plate which allows the wave plate to be produced easily by processing and at low cost.

In the case where the total sum of the phase shifts caused by the wave plates 14 and 15 to the DVD light beam 101d is about 90°, almost no component of the light reflected from the optical disc is reflected by the polarization beam splitter 13 and proceeds toward the light source 100d. The total sum of the phase shifts may be set to be deviated by about 20° from 90°, i.e., to about 70° or 110° in order to increase the amount of the light proceeding toward the light source 100d. There is experimental data which shows that by such a setting, a good reproduction performance is occasionally obtained. The reason for this is that, for example, the presence of a certain amount of the light proceeding toward the light source 100d causes interference between the light beam emitted by the light source 100d and the light beam reflected by the optical disc, which reduces the noise of the light beam emitted by the light source 100d.

Similarly, in the case where the total sum of the phase shifts caused by the wave plates 14 and 15 to the BD light beam 102b is about 90°, almost no component of the light reflected from the optical disc is reflected by the polarization beam splitter 104 and proceeds toward the light source 100b. The total sum of the phase shifts may be set to be deviated by about 20° from 90°, i.e., to about 70° or 110° in order to increase the amount of the light proceeding toward the light source 100b. There is experimental data which shows that by such a setting, a good reproduction performance is occasionally obtained like in the above case.

Similarly, the total sum of the phase shifts may be set to be deviated by about 20° from 270°, i.e., to about 250° or 290°. In this case also, substantially the same effect is obtained.

From the above, the total sum of the phase shifts caused by the first wave plate 14 and the second wave plate 15 to the DVD light beam and the BD light beam can be represented as (2i+1)×90°±20° (i is an integer).

The total sum of the phase shifts caused to the CD light beam may be deviated by about ±20° from 0°. The polarization beam splitter 13 having a characteristic as in this example (polarizability on the BD and DVD light beams) also has a certain degree of polarizability on the CD light beam. Therefore, when the total sum of the phase shifts is deviated by about ±20° from 0°, the amount of the CD light beam transmitted through the polarization beam splitter 13 and incident on the light detector is changed. However, there is experimental data which shows that the influence thereof on the recording/reproduction performance is small and the structure with the above-mentioned deviation is practically usable.

The structure described in this embodiment allows the height H′ of the optical system to be reduced and also realizes a good recording/reproduction performance using low-cost wave plates. Thus, the thickness reduction and size reduction of the optical pickup device can be realized.

The first wave plate 14 and the second wave plate 15 may be integrated together. In this case, the wave plates can be rigid as an integral body. Therefore, even where the crystal thickness of each wave plate is made smaller using smaller values of n and m, a wave plate can be produced with good processability. This is advantageous to produce a still lower-cost wave plate. Thus, low-cost optical pickup device and optical disc device can be realized.

Instead of the relay lens 110 (FIG. 1(b)), an integral body of the relay lens 110 and the chromatic aberration correction element 113 may be located. More specifically, the relay lens 110 and the chromatic aberration correction element 113 may be put together to be integral, or a lens having the functions of the relay lens 110 and the chromatic aberration correction element 113 may be used. In this case, the optical element located between the first mirror 16 and the second mirror 111 in FIG. 1 can be omitted. Therefore, the distance between the first mirror 16 and the second mirror 111, and the distance between the first objective lens 108 and the second objective lens 114, can be decreased. This can further reduce the size and cost of the optical pickup device.

In the optical pickup device 1 in this embodiment, the light source module 100 including the first light source 100d and the third light source 100c in a common package is used. The second light source 100b may also be integrated in the common package. In this case, the beam splitter 104 can be omitted, which is advantageous for further size and cost reduction of the optical pickup device 1.

### Embodiment 2

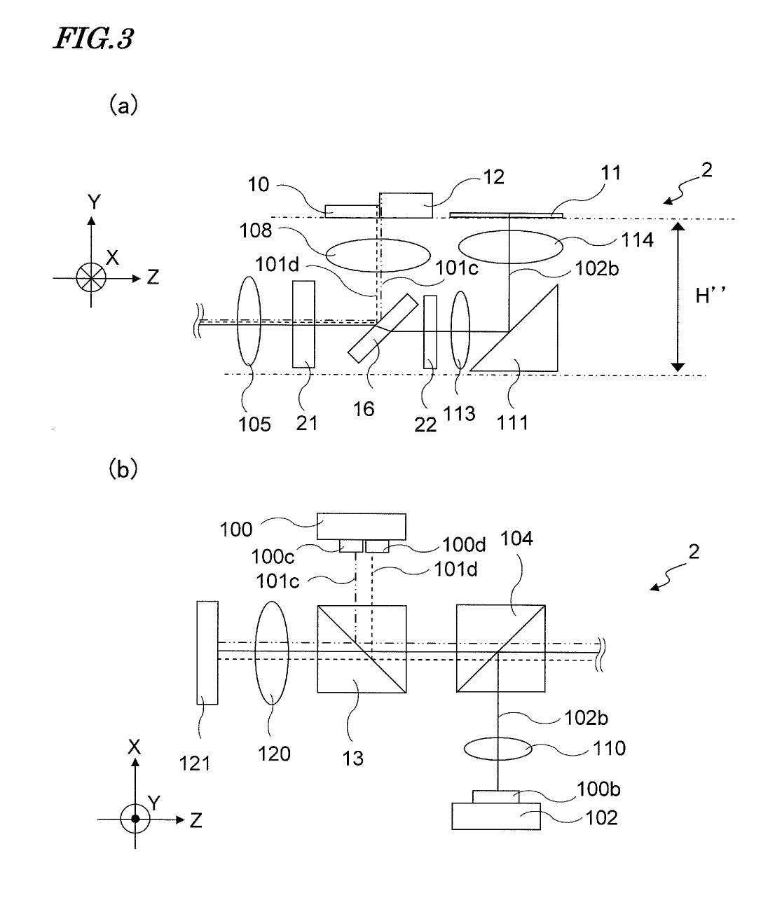

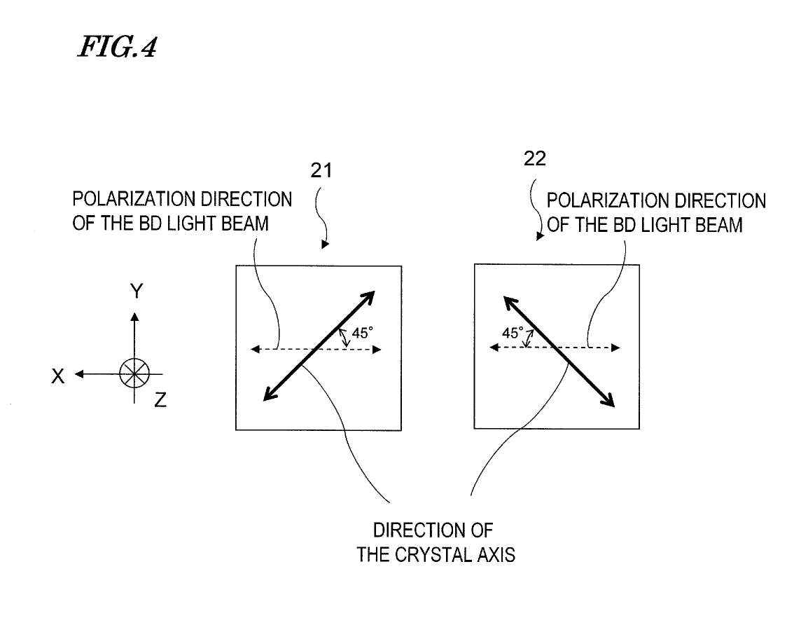

Now, with reference to FIGS. 3 and 4, an optical pickup device 2 in Embodiment 2 of the present invention will be described. Substantially the same elements as those of the optical pickup device 1 in Embodiment 1 will bear the identical reference numerals thereto, and detailed descriptions thereof will not be repeated.

Like FIG. 1, FIG. 3(a) is a schematic view of an optical system of the optical pickup device 2 as seen in the X direction, and FIG. 3(b) is a schematic view of the optical system of the optical pickup device 2 as seen in the Y direction. In FIG. 3, the BD light beam 102b is represented with a solid line, the DVD light beam 101d is represented with a dashed line, and the CD light beam 101c is represented with a two-dot chain line. The optical pickup device 2 is a two-lens optical pickup device including two objective lenses, and can collect a light beam to at least three types of optical discs for data recording/reproduction. In this embodiment, BD, DVD and CD will be described as examples of the optical discs.

Referring to FIG. 3(b), in the light source module 100, a plurality of light sources respectively for emitting light beams of two wavelengths used for performing recording on and reproduction from DVDs and CDs (660 nm, 790 nm) are integrated in one package. On the light beam module 100, the first light source 100d for emitting the DVD light beam 101d and the third light source 100c for emitting the CD light beam 101c are mounted.

The DVD light beam 101d emitted by the first light source 100d is straight polarization polarized in the direction along the Z axis shown in the figure and is incident on the polarization beam splitter 13. The polarization film of the polarization beam splitter 13 has a characteristic of reflecting a light beam having the same polarization direction as that of the DVD light beam 101d emitted by the first light source 100d (direction along the Z axis) and transmitting a light beam having a polarization direction perpendicular thereto (direction along the Y axis). The DVD light beam 101d is reflected by the polarization beam splitter 13 to have the polarization direction thereof changed to be along the X axis and is incident on the polarization beam splitter 104.

The polarization beam splitter 104 has a characteristic of transmitting light having the wavelength of the DVD light beam 101d. Therefore, the DVD light beam 101d passes the polarization beam splitter 104, is incident on the collimator lens 105 (FIG. 3(a)) to become collimated light, and is incident on a first wave plate 21.

The thickness d₁ of the first wave plate 21 is set such that the phase shift caused by the first wave plate 21 is 90° or 270° to light having the wavelength λ_{d} of the DVD light beam 101d and 0° to light having the wavelength λ_{c} of the CD light beam 101c.

For example, where λ_{b}=405 nm, λ_{d}=660 nm, and λ_{c}=795 nm; the refractive index difference at the crystal forming the first wave plate 21 is Δnλ_{b} at λ_{b}, Δnλ_{d} at λ_{d}, and Δnλ_{c} at λ_{c}; and Δnλ_{b}=Δnλ_{d}=Δnλ_{c}=0.01; the crystal thickness d₁ is set to 82.5 μm.

At this point, the retardation Γ₁ of the first wave plate 21 is Γ₁=825 nm, and the following expression holds.

Γ₁=(1+¼)×λ_{d}≈2×λ_{b}≈1×λ_{c} (expression 15)

Therefore, the phase shift caused to the DVD light beam 101d is 90°, and the phase shift caused to the BD light beam 102b and the CD light beam 101c is 0°.

The first wave plate 21 is located such that a crystal axis having optical anisotropy has an angle of 45° with respect to the polarization direction of the DVD light beam (direction along the X axis) on the X-Y plane. Therefore, the DVD light beam 101d is converted into circular polarization and is incident on the first mirror 16.

The first mirror 16 has a characteristic of reflecting a light beam having the wavelength of the DVD light beam 101d. Therefore, the DVD light beam 101d is reflected by the first mirror 16 and is collected by the first objective lens 108 to be directed to the DVD 10 thus to form a light spot.

The DVD light beam 101d, which has been reflected by the DVD 10, again passes the first objective lens 108, is reflected by the first mirror 16, and is converted by the first wave plate 21 into straight polarization of a direction perpendicular to the light beam proceeding toward the DVD 10 (straight polarization of the direction along the Y axis). Then, the DVD light beam 101d passes the collimator lens 105, is transmitted through the polarization beam splitter 104 (FIG. 3(b)), and is incident on the polarization beam splitter 13. The polarization beam splitter 13 transmits a light beam having a polarization direction along the Y axis. Therefore, the DVD light beam 101d is transmitted through the polarization beam splitter 13, passes the detection lens 120, and is incident on the light detector 121. Thus, various signals including a tracking error signal and a focusing error signal are obtained.

Meanwhile, the BD light beam 102b emitted by the second light source 100b mounted on the laser light source 102 (FIG. 3(b)) is straight polarization polarized in the direction along the Z axis, and passes the relay lens 110 and is incident on the polarization beam splitter 104. The polarization film of the polarization beam splitter 104 has a characteristic of reflecting a light beam having the same polarization direction as that of the BD light beam 102b emitted by the second light source 100b (direction along the Z axis) or a light beam having a polarization direction along the X axis, and transmitting a light beam having a polarization direction perpendicular thereto, i.e., a polarization direction along the Y axis. Therefore, the BD light beam 102b is reflected by the polarization beam splitter 104, is incident on the collimator lens 105 to become collimated light, and is incident on the first wave plate 21.

The first mirror 16 has a characteristic of transmitting a light beam having the wavelength of the BD light beam 102b. Therefore, the BD light beam 102b is transmitted through the first mirror 16 and is incident on a second wave plate 22.

Crystal thicknesses d₁ and d₂ of the two wave plates, namely, the first wave plate 21 and the second wave plate 22 are each set such that the phase shift caused by the BD light beam 102b passing through the first wave plate 21 and the second wave plate 22 is 90° or 270°.

In the optical pickup device 2 in this embodiment shown in FIG. 3, the first wave plate 21 is set such that the phase shift caused to the light having the wavelength λ_{b} of the BD light beam 102b is 0° based on expression 15. The crystal thickness d₂ of the second wave plate 22 is set such that the phase shift caused is 90° or 270°.

For example, where λ_{b}=405 nm, the refractive index difference at the crystal forming the first wave plate 22 is Δnλ_{b} at λ_{b}, and Δnλ_{b}=0.01, the crystal thickness d₁ is set to 91.1 μm.

At this point, the retardation Γ₂ of the second wave plate 22 is Γ₂=911 nm, and the following expression holds.

Γ₂=(2+¼)×λ_{b} (expression 16)

Therefore, the phase shift caused to the BD light beam 102b is 90°.

The second wave plate 22 is located such that a crystal axis, having optical anisotropy, of the crystal forming the second wave plate 22 has an angle of 45° with respect to the polarization direction of the BD light beam 102b (direction along the X axis) on the X-Y plane. Therefore, the BD light beam 102b is converted into circular polarization, passes the chromatic aberration correction element 113, is reflected by the second mirror 111, and is collected by the second objective lens 114 to be directed to the BD 11 thus to form a light spot. The chromatic aberration correction element 113 is used for correcting an axial chromatic aberration caused at the second objective lens 114.

The BD light beam 102b, which has been reflected by the BD 11, again passes the second objective lens 114, is reflected by the second mirror 111, passes the chromatic aberration correction element 113, is converted by the second wave plate 22 into straight polarization perpendicular to the light beam proceeding toward the BD 11, i.e., straight polarization of the direction along the Y axis, and is incident on the first mirror 16. The first mirror 16 has a characteristic of transmitting a light beam having the wavelength of the BD light beam 102b. Therefore, the BD light beam is transmitted through the first mirror 16, is transmitted through the collimator lens 105 and the polarization beam splitter 104, and is incident on the polarization beam splitter 13.

The polarization beam splitter 13 has a characteristic of transmitting a light beam having the wavelength of the BD light beam 102b. Therefore, the BD light beam 102b is transmitted through the polarization beam splitter 13, passes the detection lens 120, and is incident on the light detector 121. Thus, various signals including a tracking error signal and a focusing error signal are obtained.

The CD light beam 101c emitted by the third light source 100c is straight polarization polarized in the direction along the Z axis shown in the figure, and is incident on the polarization beam splitter 13. The CD light beam 101c, which has been incident on the polarization beam splitter 13, is divided into a light beam reflected by the polarization beam splitter 13 and a light beam transmitted through the polarization beam splitter 13. The CD light beam 101c reflected by the polarization beam splitter 13 has the polarization direction thereof changed to be along the X axis and is incident on the polarization beam splitter 104.

The polarization beam splitter 104 has a characteristic of transmitting a light beam having the wavelength of the CD light beam 101c. Therefore, the CD light beam 101c passes the polarization beam splitter 104, is incident on the collimator lens 105 to become collimated light, and is incident on the first wave plate 21.

The first wave plate 21 causes a phase shift of 0° to a light beam having the wavelength λ_{c} of the CD light beam. Therefore, the polarization state of the CD light beam is not changed, and the CD light beam is incident on the first mirror 16 while keeping the polarization direction along the X axis.

The first mirror 16 has a characteristic of reflecting a light beam having the wavelength of the CD light beam 101c. Therefore, the CD light beam 101c is reflected by the first mirror 16 and is collected by the first objective lens 108 to be directed to the CD 12 while keeping the polarization direction along the X axis thus to form a light spot.

The CD light beam 101c, which has been reflected by the CD 12, again passes the first objective lens 108, is reflected by the first mirror 16, passes the first wave plate 21 while keeping the polarization direction along the X axis, passes the collimator lens 105, is transmitted through the polarization beam splitter 104, and is incident on the polarization beam splitter 13. Because of the characteristic of the polarization film of the polarization beam splitter 13, the CD light beam 101c is divided into a light beam reflected by the polarization beam splitter 13 and a light beam transmitted through the polarization beam splitter 13. The CD light beam 101c transmitted through the polarization beam splitter 13 passes the detection lens 120 and is incident on the light detector 121. Thus, various signals including a tracking error signal and a focusing error signal are obtained.

Like in the optical pickup device 1 in Embodiment 1, the CD light beam 101c incident on the CD 12 is straight polarization having a polarization direction along the X axis. Therefore, no phase shift is caused to the CD light beam 101c even when the substrate of the CD 12 has a large birefringence. The CD light beam 101c, which has been incident on, and reflected by, the CD 12, is straight polarization having a polarization direction along the X axis.

Therefore, in this case also, the ratio of the CD light beam 101c transmitted through the polarization beam splitter 13 is the same as that in the case where the substrate of the CD 12 does not have a birefringence. The amount of the light beam 101c which passes the detection lens 120 and is incident on the light detector 121 is the same.

Therefore, the amount of the CD light beam 101c incident on the light detector 121 is the same regardless of the amount of the birefringence of the CD 12. For this reason, a good quality signal can be obtained, and a good recording/reproduction performance is obtained.

Owing to the above-described structure, a polarization optical system capable of obtaining a sufficient utilization factor of the light beam from the light source for performing recording on and reproduction from a BD and a DVD and thus guiding the light reflected from a low reflectance disc to the light detector efficiently can be realized. Also a good quality signal can be obtained for a CD having a birefringence. By providing the above-described features and also adopting a structure in which only the objective lenses are located as optical elements in a height direction of the optical system, the height H′ represented with the two-headed arrow in FIG. 3(a) can be reduced. Owing to these features, a thin and compact optical pickup device having a good recording/reproduction performance can be realized.

In the optical pickup device 2 in this embodiment, the phase shift caused by the first wave plate 21 is set to 90° or 270° to a light beam having the wavelength λ_{d} of the DVD light beam 101d and to 0° to a light beam having the wavelength λ_{c} of the CD light beam 101c. In order to set the phase shift caused by the BD light beam 102b passing two wave plates, i.e., the first wave plate 21 and the second wave plate 22 to 90° or 270°, the first wave plate 21 is set to cause a phase shift of 90° or 270° to a light beam having the wavelength λ_{d} of the DVD light beam 101d and a phase shift of 0° to a light beam having the wavelength λ_{b} of the BD light beam 102b and a light beam having the wavelength λ_{c} of the CD light beam 101c. The second wave plate 22 is set to cause a phase shift of 90° or 270° to a light beam having the wavelength λ_{b} of the BD light beam 102b. The present invention is not limited to this combination, and any other combination is usable as long as the same phase shifts are caused.

For example, in the case where the phase shift caused by the first wave plate 21 to the BD light beam is other than 0°, a total sum of the phase shifts caused to the BD light beam when the BD light beam passes the first wave plate and the second wave plate can be 90° or 270° by setting the phase shift caused by the second wave plate 22 to the BD light beam to a desirable value.

In this case, the crystal thickness d₁ of the first wave plate 21 is set such that a desirable phase shift is caused to the DVD light beam 101d and the CD light beam 101c. The crystal thickness d₂ of the second wave plate 22 is set such that a total sum of the phase shifts caused to the BD light beam 102b by the first wave plate 21 having the set thickness d₁ and by the second wave plate 22 is a desirable value. With such a structure, a larger number of combinations of the crystal thicknesses d₁ and d₂ are conceivable. Therefore, the degree of designing freedom is increased.

The light beam which passes the second wave plate 22 is only the BD light beam 22. Therefore, when setting the crystal thickness d₂ of the second wave plate 22, it is not necessary to consider the DVD light beam 101d or the CD light beam 101c. This allows the phase shift caused to the BD light beam to be set more precisely. As a result, the BD light beam can be easily set to be in a more ideal polarization state, which improves the utilization factor of the light beam on forward and backward paths and realizes a good BD recording/reproduction performance.

In the above-described structure, a crystal axis of the first wave plate 21 and a crystal axis of the second wave plate 22 may be perpendicular to each other.

In the optical pickup device in this embodiment, the crystal thickness d₁ of the first wave plate 21 is set such that the phase shift is 0° to a light beam having the wavelength λ_{b} of the BD light beam 102b and a light beam having the wavelength λ_{c} of the CD light beam 101c and is 90° or 270° to a light beam having the wavelength λ_{d} of the DVD light beam 101d. This is realized by, for example, the following. Where λ_{b}=405 nm, λ_{d}=660 nm, and λ_{c}=795 nm; the refractive index difference at the crystal forming the first wave plate 14 is Δnλ_{b} at λ_{b}, Δnλ_{d} at λ_{d}, and Δnλ_{c} at λ_{c}; Δnλ_{b}=Δnλ_{d}=Δnλ_{c}=0.01; the crystal thickness d₁ is set to 82.5 μm so that the retardation Γ₁ is 825 nm.

In general, however, the wave plate cannot be produced at low cost because it is difficult or costly to process quartz to a thickness of 82.5 μm highly precisely and also other elements for holding the crystal is required to make the wave plate rigid.

Therefore, the following is needed. The retardation Γ₁ of the wave plate is represented by:

Γ₁=λ_{d}×N(N=1,2,3, . . . ) (expression 17)

In expression 17, a large value needs to be used as “N” such that that the required thickness of the crystal is a thickness to which the crystal is processable. For example, in the case where N=6 and λ_{b}=405 nm, the retardation Γ₁ of the wave plate is Γ₁=405×6=2430 nm. In this case, the required thickness of the quartz is 243 μm, to which the quartz can be processed easily. By increasing the value of “n”, the thickness of the crystal can be increased. Thus, the processability is improved, which allows the wave plate to be produced at lower cost.

Similarly, the second wave plate 22 is set to cause a phase shift of 90° or 270° to the BD light beam 102b having the wavelength λ_{b}. Therefore, the thickness of the second wave plate 15 is set such that the retardation Γ₂ thereof is:

Γ₂=λ_{b}×(M±¼)(M=1,2,3, . . . ) (expression 18)

For example, in the case where M=6 and λ_{b}=405 nm, the retardation Γ₂ of the wave plate is Γ₂=405×(6+¼)=2530 nm. In this case, the required thickness of the quartz is 253 μm.

However, it is generally known that when the ambient temperature or the intensity of the light beam emitted by the light source is changed, the wavelength of the light beam is changed. When the wavelength λ_{b} of the BD light beam is changed to λ_{b}′, the first wave plate 21, which is set to cause a phase shift of 0° to the BD light beam having the wavelength λ_{b}, causes a phase shift having a certain error with respect to 0° to the BD light beam having the wavelength kb, based on expression 17.

Similarly, at this point, the phase shift caused by the second wave plate 22 also has a certain error with respect to 90° or 270°.

An ideal retardation Γ₁′ for causing a phase shift of 0° by the first wave plate 21 to the BD light beam having the wavelength λ_{b}′ is:

Γ₁′=λ_{b}′×N (expression 19)

An ideal retardation Γ₂′ for causing a the phase shift of 90° or 270° by the second wave plate 22 to the BD light beam having the wavelength λ_{b}′ is:

Γ₂′=λ_{b}′×(M±¼) (expression 20)

At this point, retardation errors ΔΓ₁ and ΔΓ₂ corresponding to the errors of the phase shifts caused by the first and second wave plates are respectively as follows based on expressions 17 through 20.

$$\begin{matrix}\begin{matrix}{ΔΓ}_{1} = {Γ}_{1} - {Γ}_{1}^{′} \\ = {λ}_{b} \times N - {λ}_{b}^{′} \times N \\ = ( {λ}_{b} - {λ}_{b}^{′} ) \times N\end{matrix} & ( expression 21 ) \\ \begin{matrix}{ΔΓ}_{2} = {Γ}_{2} - {Γ}_{2}^{′} \\ = {λ}_{b} \times ( M \pm 1 / 4 ) - {λ}_{b}^{′} \times ( M \pm 1 / 4 ) \\ = ( {λ}_{b} - {λ}_{b}^{′} ) \times ( M \pm 1 / 4 )\end{matrix} & ( expression 22 )\end{matrix}$$

As a result, a retardation error ΔΓ_{b} corresponding to the total sum of the phase shift errors caused by the BD light beam having the wavelength λ_{b}′ passing the first wave plate 21 and the second wave plate 22 is:

$$\begin{matrix}{ΔΓ}_{d} = {ΔΓ}_{1} + {ΔΓ}_{2} \\ = ( {λ}_{b} - {λ}_{b}^{′} ) \times ( N + M \pm 1 / 4 )\end{matrix} \qquad ( expression 23 )$$

Accordingly, at the first wave plate 21, because of the phase shift error corresponding to ΔΓ₁, the BD light beam 102b is changed to elliptical polarization from the straight polarization of the direction along the X axis. At the second wave plate 22, on which the BD light beam is incident as the elliptical polarization, as a result of the phase shift error corresponding to ΔΓ₂ being added, the BD light beam 102b is further converted into elliptical polarization diverged from the circular polarization.

The BD light beam 102b, which has been incident on, and reflected by, the BD 11 and again incident on the second wave plate 22, is again converted into elliptical polarization diverged from the straight polarization of the direction along the Y axis because of the phase shift corresponding to ΔΓ₂, passes the first mirror 16, and is incident on the first wave plate 21. At the first wave plate 21, the BD light beam 102b is further converted into elliptical polarization more diverged from the straight polarization of the direction along the Y axis because of the phase shift error corresponding to ΔΓ₁ and is incident on the polarization beam splitter 104.

At this point, the polarization beam splitter 104 transmits a light beam having a polarization direction along the Y axis and reflects a light beam having a polarization direction along the X axis. The BD light beam, which is converted into the elliptical polarization, includes a component which has a polarization direction along the X axis and does not proceed toward the light detector 121. Therefore, the amount of the BD light beam 102b incident on the light detector 121 is decreased. Therefore, the amount of the light required for performing recording on or reproduction from the BD 11 is not obtained, and so the recording/reproduction performance is deteriorated.

Especially according to expression 23, when the thickness is increased, i.e., the values of N and M are increased in order to allow the first and second wave plates to be produced by processing, the retardation error ΔΓ_{b} is increased. Therefore, the phase shift error caused when the light passes the first and second wave plates reciprocally is still increased and the amount of component proceeding toward the light detector 121 is still decreased. As a result, the amount of the light obtained at the light detector 121 is still decreased, which further deteriorates the recording/reproduction performance.

In order to solve this problem, in this embodiment, the crystal axis of the first wave plate 21 and the crystal axis of the second wave plate 22 are located to be perpendicular to each other as shown in FIG. 4.

FIG. 4 is a plan view showing the crystalline axes of the wave plates as seen in the direction in which the BD light beam 102b emitted by the second light source 100b and proceeding toward the BD 11 is incident on the wave plates. In FIG. 4, the crystal axis of the first wave plate 21 (represented with the thick solid arrow in the figure) is set to a direction of 45° counterclockwise with respect to the polarization direction of the BD light beam 102b (direction along the X axis; represented with the dashed line in the figure) on the X-Y plane. The crystal axis of the second wave plate 22 (represented with the thick solid arrow in the figure) is set to a direction of 45° clockwise with respect to the polarization direction of the BD light beam 102b (direction along the X axis; represented with the dashed line in the figure) on the X-Y plane.

The second wave plate 22 is set to cause a phase shift of 90° or 270° to the BD light beam 102b having the wavelength λ_{b}. The crystalline axes of the first wave plate 21 and the second wave plate 22 are perpendicular to each other. Therefore, the phase shift caused by the first wave plate 21 and the phase shift caused by the second wave plate 22 are of opposite polarity to each other. The retardation Γ₂ of the second wave plate 22 is:

Γ₂=−λ_{b}×(M±¼)(M=1,2,3, . . . ) (expression 24)

Meanwhile, the ideal retardation Γ₂′ for causing a phase shift of 90° or 270° by the second wave plate 22 to the BD light beam having the wavelength λ_{b}′ is:

Γ₂′=−λ_{b}′×(M±¼) (expression 25)

At this point, the retardation error ΔΓ₂ corresponding to the phase shift error caused by the second wave plate 22 is:

$$\begin{matrix}{ΔΓ}_{2} = {Γ}_{2} - {Γ}_{2}^{′} \\ = - {λ}_{b} \times ( M \pm 1 / 4 ) - \{ - {λ}_{b}^{′} \times ( M \pm 1 / 4 ) \} \\ = - ( {λ}_{b} - {λ}_{b}^{′} ) \times ( M \pm 1 / 4 )\end{matrix} \qquad ( expression 26 )$$

As a result, the retardation error ΔΓ_{b} corresponding to the total sum of the phase shift errors caused by the BD light beam having the wavelength λ_{b}′ passing the first wave plate and the second wave plate is:

$$\begin{matrix}{ΔΓ}_{b} = {ΔΓ}_{1} + {ΔΓ}_{2} \\ = - ( {λ}_{b} - {λ}_{b}^{′} ) \times ( N - M \pm 1 / 4 )\end{matrix} \qquad ( expression 27 )$$

Therefore, according to expression 27, by selecting the value of each of N and M so as to decrease the value of (N−M), the retardation error ΔΓ_{b} can be decreased and the corresponding phase shift error can be decreased.

Therefore, even in the case where the wavelength of the BD beam light is changed when the crystal thicknesses, i.e., the values of N and M are set to have large values in order to allow the wave plates to be produced at lower cost, the divergence of the polarization state of the BD light beam from the desirable polarization state can be suppressed to be small. Thus, the decrease of the amount of the light incident on the light detector 121 can be suppressed and the deterioration of the BD recording/reproduction performance can be suppressed. By setting N=M, the retardation error ΔΓ_{b} can be minimized.

In the case where the phase shift caused by the wave plate 21 to the DVD light beam 101d is about 90°, almost no component of light reflected from the optical disc is reflected by the polarization beam splitter 13 and proceeds toward the light source 100d. The phase shift may be set to be deviated by about 20° from 90°, i.e., to about 70° or 110° in order to increase the amount of the light proceeding toward the light source 100d. There is experimental data which shows that by such a setting, a good reproduction performance is occasionally obtained.

Similarly, in the case where the total sum of the phase shifts caused by the wave plates 21 and 22 to the BD light beam 102b is about 90°, almost no component of the light reflected from the optical disc is reflected by the polarization beam splitter 104 and proceeds toward the light source 100b. The total sum of the phase shifts may be set to be deviated by about 20° from 90°, i.e., to about 70° or 110° in order to increase the amount of the light proceeding toward the light source 100b. There is experimental data which shows that by such a setting, a good reproduction performance is occasionally obtained like in the above case.

Similarly, the phase shift or the total sum of the phase shifts may be set to be deviated by about 20° from 270°, i.e., to about 250° or 290°. In this case also, substantially the same effect is obtained.

From the above, the phase shift caused by the first wave plate 21 to the DVD light beam can be represented as (2i+1)×90°±20° (i is an integer). The total sum of the phase shifts caused by the first wave plate 21 and the second wave plate 22 to the BD light beam can be represented as (2i+1)×90°±20°.

The phase shift caused by the first wave plate 21 to the CD light beam may be deviated by about ±20° from 0°. The polarization beam splitter 13 having a characteristic as in this example (polarizability on the BD and DVD light beams) also has a certain degree of polarizability on the CD light beam. Therefore, when the total sum of the phase shifts is deviated by about ±20° from 0°, the amount of the CD light beam transmitted through the polarization beam splitter 13 and incident on the light detector is changed. However, there is experimental data which shows that the influence thereof on the recording/reproduction performance is small and the structure with the above-mentioned deviation is practically usable.

The structure described in this embodiment allows the height H′ of the optical system to be reduced and also realizes a good recording/reproduction performance using low-cost wave plates. Thus, the thickness reduction and size reduction of the optical pickup device are realized.

The structure of the optical system of the optical pickup device 2 in this embodiment is one example. For example, the first wave plate 21 may be located between the polarization beam splitter 104 and the collimator lens 105. The structure of the optical system is not limited to the one in this embodiment.

Instead of the relay lens 110 (FIG. 3(b)), an integral body of the relay lens 110 and the chromatic aberration correction element 113 may be located. More specifically, the relay lens 110 and the chromatic aberration correction element 113 may be put together to be integral, or a lens having the functions of the relay lens 110 and the chromatic aberration correction element 113 may be used. In this case, only the second wave plate 22 is located as an optical element between the first mirror 16 and the second mirror 111 in FIG. 3. Therefore, the distance between the first mirror 16 and the second mirror 111, and the distance between the first objective lens 108 and the second objective lens 114, can be decreased. This can further reduce the size and cost of the optical pickup device.

In the optical pickup device 2 in this embodiment, the light source module 100 including the first light source 100d and the third light source 100c in a common package is used. The second light source 100b may also be integrated in the common package. In this case, the beam splitter 104 can be omitted, which is advantageous for further size and cost reduction of the optical pickup device 1.

As described above, the optical pickup device and the optical disc device according to the present invention are useful for a device for optically recording information on or reproducing information from an information recording medium using a laser light source.

The present invention claims priority based on a Japanese patent application filed on Jun. 11, 2009 (Japanese Patent Application No. 2009-139736), and the descriptions thereof is incorporated herein by reference.

1. An optical pickup device including a first objective lens and a second objective lens and capable of collecting a light beam to at least three types of optical discs, the optical pickup device comprising:
a first light source for emitting a light beam of a first wavelength;
a second light source for emitting a light beam of a second wavelength;
a third light source for emitting a light beam of a third wavelength;
a first mirror for reflecting the light beam of the first wavelength and the light beam of the third wavelength and transmitting the light beam of the second wavelength;
a second mirror for reflecting the light beam of the second wavelength which has been transmitted through the first mirror;
a first wave plate located between the first light source and the first mirror; and
a second wave plate located between the second light source and the second mirror;
wherein:
the first objective lens collects the light beam of the first wavelength and the light beam of the third wavelength, which have been reflected by the first mirror, on a first optical disc and a third optical disc, respectively;
the second objective lens collects the light beam of the second wavelength, which has been reflected by the second mirror, on a second optical disc; and
a total sum of phase shifts caused by the first wave plate and the second wave plate is:
(2i+1)×90°±20° to the light beam of the first wavelength (i is an integer),
(2i+1)×90°±20° to the light beam of the second wavelength, and
0°±20° to the light of the third wavelength.

2. The optical pickup device of claim 1, wherein a crystal axis of the first wave plate and a crystal axis of the second wave plate are perpendicular to each other.

3. The optical pickup device of claim 1, wherein the first wave plate and the second wave plate are integrated together.

4. The optical pickup device of claim 1, further comprising:
a chromatic aberration correction element for correcting an axial chromatic aberration caused at the second objective lens; and
a relay lens for improving a utilization factor of the light beam of the second wavelength;
wherein the chromatic aberration correction element and the relay lens are integrated together.

5. The optical pickup device of claim 1, wherein the first light source and the third light source are integrated in a common package.

6. The optical pickup device of claim 1, wherein the first light source, the second light source and the third light source are integrated in a common package.

7. An optical pickup device including a first objective lens and a second objective lens and capable of collecting a light beam to at least three types of optical discs, the optical pickup device comprising:
a first light source for emitting a light beam of a first wavelength;
a second light source for emitting a light beam of a second wavelength;
a third light source for emitting a light beam of a third wavelength;
a first mirror for reflecting the light beam of the first wavelength and the light beam of the third wavelength and transmitting the light beam of the second wavelength;
a second mirror for reflecting the light beam of the second wavelength which has been transmitted through the first mirror;
a first wave plate located between the first light source and the first mirror; and
a second wave plate located between the first mirror and the second mirror;
wherein:
the first objective lens collects the light beam of the first wavelength and the light beam of the third wavelength, which have been reflected by the first mirror, on a first optical disc and a third optical disc, respectively;
the second objective lens collects the light beam of the second wavelength, which has been reflected by the second mirror, on a second optical disc; and
a phase shift caused by the first wave plate to the light beam of the first wavelength is (2i+1)×90°±20° (i is an integer);
a total sum of phase shifts caused by the first wave plate and the second wave plate to the light beam of the second wavelength is (2i+1)×90°±20°; and
a phase shift caused by the first wave plate to the light beam of the third wavelength is 0°±20°.

8. The optical pickup device of claim 7, wherein a phase shift caused by the first wave plate to the light beam of the second wavelength is 0°.

9. The optical pickup device of claim 7, wherein a crystal axis of the first wave plate and a crystal axis of the second wave plate are perpendicular to each other.

10. The optical pickup device of claim 7, further comprising:
a chromatic aberration correction element for correcting an axial chromatic aberration caused at the second objective lens; and
a relay lens for improving a utilization factor of the light beam of the second wavelength;
wherein the chromatic aberration correction element and the relay lens are integrated together.

11. The optical pickup device of claim 7, wherein the first light source and the third light source are integrated in a common package.

12. The optical pickup device of claim 7, wherein the first light source, the second light source and the third light source are integrated in a common package.
